(19) United States
(12) Patent Application Publication
(10) Pub. No.: US 2008/0135362 A1
(43) Pub. Date: Jun. 12, 2008

(54) HYDRAULIC SHOCK ABSORBER

(75) Inventors: Kouji Sakai, Shizuoka (JP); Takashi Kawai, Shizuoka (JP); Naoki Onda, Shizuoka (JP)

Correspondence Address: YAMAHA HATSUDOKI KABUSHIKI KAISHA;C/O KEATING & BENNETT, LLP, 8180 GREENSBORO DRIVE, SUITE 850, MCLEAN, VA, 22102, US

(73) Assignee: YAMAHA HATSUDOKI KABUSHIKI KAISHA, Iwata-shi (JP)

(21) Appl. No.: 11/951,931

(22) Filed: Dec. 6, 2007

(30) Foreign Application Priority Data
Dec. 6, 2006 (JP) 2006-330033

(51) Int. Cl. F16F 9/10

(52) U.S. Cl. 188/317

(57) ABSTRACT

A shock absorber includes a cylinder tube, a piston fitted slidably in an axial direction in the cylinder tube and arranged to divide an inside of the cylinder tube into first and second fluid chambers, a piston rod extending from the piston to an outside of the cylinder tube, and damping force generation sections arranged to generate a damping force by making hydraulic fluid flow between the first and the second fluid chambers. Cavities are formed in at least one of the cylinder tube and the piston rod. Flowable matter having a rheological characteristic is sealed in the cavities.

### BACKGROUND OF THE INVENTION

1. Field of the Invention

The present invention relates to a hydraulic shock absorber in which a damping force is generated according to a flow of hydraulic fluid and more particularly to, a hydraulic shock absorber in which an additional damping force is generated according to a flow of a flowable matter such as granular material other than the hydraulic fluid.

2. Description of the Related Art

A conventional hydraulic shock absorber of a kind described above is disclosed in JP-A-2003-166579. According to this prior art, the shock absorber includes a cylinder tube, a piston fitted slidably in an axial direction in the cylinder tube and dividing an inside of the cylinder tube into first and second fluid chambers, a piston rod extending from the piston to an outside of the cylinder tube, a damping force generation section which can generate a damping force by making hydraulic fluid flow between the first and the second fluid chambers, and a dynamic damper supported by the piston rod in the fluid chamber. The dynamic damper is attached to the piston rod and has an elastic body made of rubber projecting outward in the radial direction of the piston rod and a weight attached to a projected end of the elastic body.

When an impact force is applied from an outside in the axial direction to the shock absorber having a constitution described above, the shock absorber is expanded or compressed. Accordingly, the hydraulic fluid in the shock absorber passes through the damping force generation section to flow between the first and the second fluid chambers. As a result, the damping force is generated, and the impact force is damped.

On the other hand, when the impact force is applied to the shock absorber as described above, vibration of a high frequency and a micro-amplitude is generated in the shock absorber. This vibration is suppressed by the dynamic damper. It is believed that the impact force is effectively damped as a result.

However, the conventional art described above has a problem described below.

Firstly, in general, the dynamic damper can efficiently suppress vibration in a certain frequency range generated in the shock absorber. Consequently, if vibration out of the frequency range is generated in the shock absorber, vibration suppression expected from the dynamic damper may result in an adverse effect.

Secondly, in general, an elastic body made of rubber is easily deteriorated over time. Consequently, there may be a problem regarding a lifetime in which a vibration suppression characteristic is deteriorated at an early stage because of deterioration of the elastic body of the dynamic damper.

Thirdly, since the dynamic damper is provided in the fluid chamber of the cylinder tube, it is necessary to increase the length in the axial direction of the cylinder tube because it is necessary to secure a space in the fluid chamber occupied by the dynamic damper. Therefore, the shock absorber tends to become large. As a result, when it is attempted to assemble and install the shock absorber to a body of a vehicle or the like, a large installation space is required, and its assembly work may become complicated. In other words, the shock absorber of a large scale may impede assembly and installation in a vehicle having a narrow or complicated installation.

### SUMMARY OF THE INVENTION

In order to overcome the problems described above, preferred embodiments of the present invention provide a shock absorber that damps impact forces applied thereto more effectively, has an improved lifetime, and is easy to assemble and install in a vehicle or the like by avoiding enlarging of the shock absorber regardless of the fact that the shock absorber can effectively damp impact forces as described above.

According to a preferred embodiment of the present invention, a hydraulic shock absorber includes: a cylinder tube; a piston fitted slidably in an axial direction in the cylinder tube and arranged to divide an inside of the cylinder tube into first and second fluid chambers; a piston rod extending from the piston to an outside of the cylinder tube; and damping force generation sections arranged to generate damping forces by causing hydraulic fluid flow between the first and the second fluid chambers; in which cavities are formed in at least one of the cylinder tube and the piston rod, and flowable matter having a rheological characteristic is sealed in the cavities.

The cavities preferably are formed in a portion of the piston rod, and an opening which makes it possible to remove or fill the flowable matter to the cavities is preferably formed at an extended end of the piston rod.

The flowable matter sealed in the cavities preferably is pressurized.

The flowable matter preferably is a granular fluid.

The flowable matter preferably includes at least either a substance including a granular fluid and a liquid having a small absolute specific gravity, or a granular fluid having an absolute specific gravity larger than that of the aforementioned substance.

The flowable matter preferably includes a granular fluid, and the granular fluid preferably includes mixes grains having different grain diameters.

The flowable matter preferably includes a granular fluid, and surface treatment is preferably performed in order to adjust a coefficient of friction of a surface of each grain constituting the granular fluid.

Adsorptive power is preferably generated respectively between components of the flowable matter, or adsorptive power is preferably generated respectively between the flowable matter and an inner surface of the cavities.

The flowable matter preferably is not completely filled in the cavities in order to maintain a space at an upper end of the cavities.

A technical scope of the present invention is not limited to various preferred embodiments described below or to a content of a drawing regardless of reference numerals used with a description above.

According to a preferred embodiment of the present invention, a hydraulic shock absorber includes: a cylinder tube; a piston fitted slidably in an axial direction in the cylinder tube and arranged to divide an inside of the cylinder tube into first and second fluid chambers; a piston rod extending from the piston to an outside of the cylinder tube; a damping force generation section arranged to generate damping forces by making hydraulic fluid flow between the first and the second fluid chambers; in which a cavity is formed in at least either one of the cylinder tube and the piston rod, and flowable matter having a rheological characteristic is enclosed in the cavity.

Consequently, when an impact force is applied from an outside to the shock absorber, the shock absorber is expanded or compressed. As a result, a damping force is generated as a result of the hydraulic fluid flowing in the damping force generation section, and the impact force is damped.

In addition, when impact force is applied to the shock absorber, vibration of a high frequency and a micro-amplitude is generated in the shock absorber. This vibration is suppressed by the flowable matter. Specifically, “deformation resistance” (viscous resistance, frictional resistance, and the like) is generated in the flowable matter by vibration generated in the shock absorber, and further “deformation resistance” (see above) of the flowable matter is also generated at an inner surface of the cavity. Consequently, the vibration is suppressed by generation of the “deformation resistance” of the flowable matter. Moreover, the flowable matter can efficiently suppress vibration in a wider frequency range in comparison with the dynamic damper according to the conventional art. As a result, the vibration is suppressed more reliably and effectively.

Specifically, according to a preferred embodiment of the shock absorber, an impact force applied to the shock absorber is damped by the damping force generation section, and vibration of a high frequency in a wide range and a micro-amplitude generated in the shock absorber by the impact force is more reliably suppressed by the flowable matter. As a result, the impact force is damped more effectively.

Further, in general, the flowable matter is not easily deteriorated over time in comparison with the elastic body made of rubber in the dynamic damper according to the conventional art. Consequently, a vibration suppression characteristic of the flowable matter is prevented from deteriorating at an early stage in the product lifecycle. As a result, improvements in a lifetime of the shock absorber are achieved.

Moreover, the flowable matter preferably is sealed in the cavity formed in the member of the cylinder tube and the piston rod. In other words, the flowable matter is provided by utilizing an inside of the member of the cylinder tube and the piston rod. Therefore, the size of the shock absorber is not increased even though the flowable matter is provided. As a result, excellent assembly and installation of the shock absorber to a vehicle or the like can be achieved by preventing any increase in size of the shock absorber despite the fact that the shock absorber can effectively damp impact force as described above.

The cavity is preferably formed in the piston rod, and the opening which makes it possible to remove or fill the flowable matter to the cavity is formed at an extended end of the piston rod.

Consequently, it is possible to remove or fill the flowable matter to the cavity from the opening outside the cylinder tube. As a result, it is possible to change or adjust a type or an amount of the flowable matter easily and conveniently without disassembling the shock absorber.

Further, the opening preferably is formed at the extended end of the piston rod. Therefore, when a seal is applied in order to close the opening, it is not necessary to take the hydraulic fluid into consideration. It is only necessary to consider a seal between a side of atmospheric air and a side in the cavity. As a result, the shock absorber can be easily formed. In addition, because a leak does not occur respectively between the hydraulic fluid and the flowable matter in the cavity, reliability of the seal is enhanced.

The flowable matter sealed in the cavity preferably is pressurized.

Consequently, in particular, when the flowable matter is a granular fluid, cohesion of each grain in the granular fluid is increased. As a result, the “deformation resistance” in the flowable matter generated by the impact force is more frequently generated, and vibration generated in the shock absorber by the impact force is suppressed more effectively.

The flowable matter preferably is a granular fluid, and more preferably is sand. Further, the granular fluid can be easily handled, for example, when filled in the cavity. In addition, a desired characteristic can be obtained relatively easily. As a result, since the flowable matter is the granular fluid, the shock absorber can be easily formed.

The flowable matter preferably includes at least one of a first granular fluid having a first absolute specific gravity and a liquid having a second absolute specific gravity, and a second granular fluid having a third absolute specific gravity larger than the first absolute specific gravity and the second absolute specific gravity.

Consequently, when the flowable matter vibrates with the shock absorber due to the impact force, the “deformation resistance” in the flowable matter is further more frequently generated because of difference in inertial force caused by difference in the absolute specific gravity between the substances. As a result, vibration generated in the shock absorber by the impact force is suppressed further more effectively.

The flowable matter preferably includes a granular fluid, and the granular fluid is preferably made of mixed grains having different grain diameters.

Consequently, a grain having a small grain diameter enters a space generated between grains having a large grain diameter. Therefore, a contact area between these grains and a contact area between an inner surface of the cavity and the flowable matter become larger. As a result, “deformation resistance” in the flowable matter generated by the impact force is further more frequently generated, and vibration generated in the shock absorber by the impact force is suppressed even more effectively.

In addition, when the flowable matter vibrates with the shock absorber due to the impact force, the “deformation resistance” in the flowable matter is further more frequently generated because of a difference in inertial force caused by difference between the grain diameters of the grains. As a result, vibration generated in the shock absorber by the impact force is suppressed further more effectively.

The flowable matter preferably includes a granular fluid, and surface treatment is preferably performed in order to adjust a coefficient of friction of a surface of each grain constituting the granular fluid.

Consequently, an amount of the “deformation resistance” in the flowable matter generated by the impact force can be made to be appropriate. In addition, if rigidity of a surface of each grain is enhanced by the surface treatment, deterioration over time of the flowable matter can be prevented, and improvement of a lifetime is achieved.

Adsorptive power preferably is generated respectively between components of the flowable matter, or adsorptive power preferably is generated respectively between the flowable matter and an inner surface of the cavity.

Consequently, because adsorptive power is generated respectively between components of the flowable matter and between the flowable matter and an inner surface of the cavity, each friction force is increased. As a result, an amount of the “deformation resistance” in the flowable matter generated by the impact force can be made to be larger.

In addition, when the shock absorber is vibrated, a state of each adsorption due to the adsorptive power and a state of separation in which the state of the adsorption is released by the vibration are repeated. Accordingly, abrupt internal agitation is generated in the flowable matter. Consequently, the “deformation resistance” in the flowable matter is further more frequently generated. As a result, vibration generated in the shock absorber by the impact force is suppressed even more effectively.

The flowable matter preferably is incompletely filled in the cavity in order to maintain a space at an upper end of the cavity.

Consequently, when the flowable matter vibrates with the shock absorber due to the impact force, fluidization of the flowable matter in the cavity is promoted by the space provided as described above. As a result, “deformation resistance” in the flowable matter generated by the impact force is more frequently generated, and vibration generated in the shock absorber by the impact force is suppressed more effectively.

Other features, elements, processes, steps, characteristics and advantages of the present invention will become more apparent from the following detailed description of preferred embodiments of the present invention with reference to the attached drawings.

### BRIEF DESCRIPTION OF DRAWINGS

FIG. 1 is a vertical cross-sectional view of a shock absorber according to a preferred embodiment of the present invention.

FIG. 2 is a view equivalent to FIG. 1 showing another preferred embodiment of the present invention.

FIG. 3 is a partially enlarged view of FIG. 2.

FIG. 4 is a view equivalent to FIG. 1 showing a further preferred embodiment of the present invention.

FIG. 5 is a view equivalent to FIG. 1 showing yet another preferred embodiment of the present invention.

FIG. 6 is a cross-sectional view taken along arrows VI-VI in FIG. 5.

### DETAILED DESCRIPTION OF PREFERRED EMBODIMENTS

Advantages and characteristics of various preferred embodiments of the present invention in relation to the shock absorber include damping an impact force applied to the shock absorber more effectively, further improving a lifetime of the shock absorber, and achieving excellent assembly and installation of the shock absorber to a vehicle or the like by avoiding any increase in size of the shock absorber regardless of the fact that the shock absorber can effectively damp impact force as described above. A best mode for carrying out the present invention is described below.

A shock absorber according to a preferred embodiment of the present invention preferably includes: a cylinder tube; a piston fitted slidably in an axial direction in the cylinder tube and arranged to divide an inside of the cylinder tube into first and second fluid chambers; a piston rod extending from the piston to an outside of the cylinder tube; and a damping force generation section arranged to generate damping force by making hydraulic fluid flow between the first and the second fluid chambers. A cavity is formed in at least one of the cylinder tube and the piston rod, and a flowable matter having a rheological characteristic is sealed in the cavity.

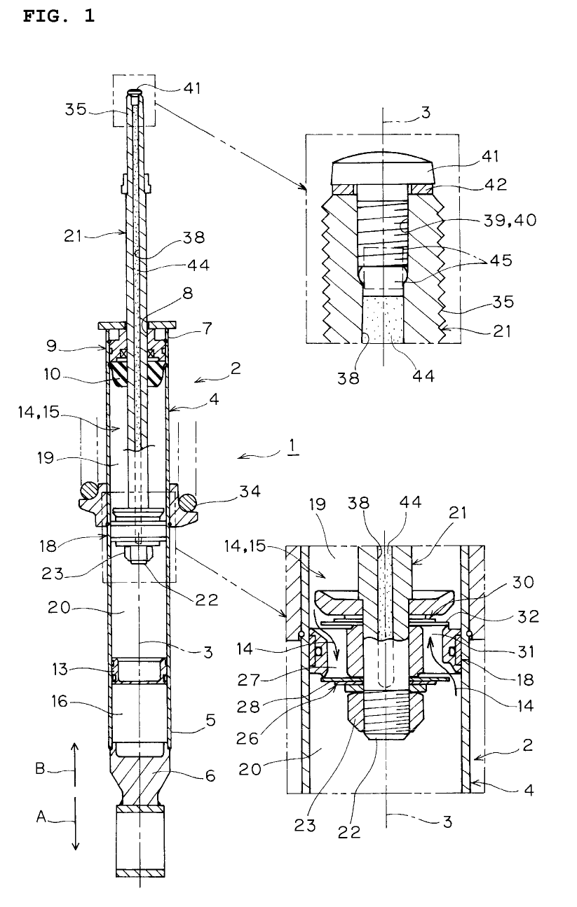

In order to describe the present invention in more detail, a first preferred embodiment will be described hereinafter with reference to the attached FIG. 1.

In FIG. 1, a reference numeral 1 denotes a hydraulic shock absorber. The shock absorber 1 is preferably applied to a suspension system, a steering damper, and the like of a vehicle such as an automobile and a motorcycle.

The shock absorber 1 is provided with the cylinder tube 2. The cylinder tube 2 is provided with a tube main body 4 positioned on an axial center 3 of the cylinder tube 2 and extending in the axial direction, a head cover 6 fixed on one end 5 so as to close an opening of the end 5 in the axial direction of the tube main body 4, a fixing rod guide 9 fixed on the other end 7 so as to close an opening of the end 7 of the tube main body 4 and having a through hole 8 formed on the axial center 3, and a bump stopper 10 attached to the fixing rod guide 9 and projecting toward the inside of the tube main body 4.

A free piston 13 is provided in the cylinder tube 2 and fitted slidably in the axial direction. The free piston 13 divides an inside of the cylinder tube 2 into an fluid chamber 15 in which hydraulic fluid 14 is filled and a gas chamber 16 in which high-pressure nitrogen gas is filled. In addition, the piston 18 is arranged to be fitted in the fluid chamber 15 of the cylinder tube 2 slidably in the axial direction. The piston 18 divides the fluid chamber 15 into the first fluid chamber 19 and the second fluid chamber 20.

The piston rod 21 positioned on the axial center 3, extending from the piston 18, passing through the through hole 8 of the fixing rod guide 9, and reaching an outside of the cylinder tube 2 is provided. A base end 22 of the piston rod 21 passes through the piston 18, and the piston 18 and the base end 22 are fixed on each other by a fastener 23.

The expansion side damping force generation section 26 is provided, which generates damping force by making the hydraulic fluid 14 flow from the first fluid chamber 19 to the second fluid chamber 20 when the shock absorber 1 performs an expanding operation A. The expansion side damping force generation section 26 is provided with an expansion side fluid passage 27 formed in the piston 18 so as to connect the first fluid chamber 19 and the second fluid chamber 20 and an expansion side damping valve 28 as a leaf valve for separating the expansion side fluid passage 27 from a side of the second fluid chamber 20 elastically in an openable and closable manner.

On the other hand, the compression side damping force generation section 30 is provided, which generates damping force by making the hydraulic fluid 14 flow from the second fluid chamber 20 to the first fluid chamber 19 when the shock absorber 1 performs a compressing operation B. The compression side damping force generation section 30 is provided with a compression side fluid passage 31 formed in the piston 18 so as to connect the first fluid chamber 19 and the second fluid chamber 20 and a compression side damping valve 32 as a leaf valve for separating the compression side fluid passage 31 from a side of the first fluid chamber 19 elastically in an openable and closable manner.

An external thread 35 is formed on an outer circumference of the extended end of the piston rod 21 of the cylinder tube 2, and the extended end of the piston rod 21 is supported on a side of the vehicle body. On the other hand, the head cover 6 of the cylinder tube 2 is connected to a side of a wheel. A suspension spring 34 for biasing the cylinder tube 2 in order to make the shock absorber 1 perform the expanding operation A is provided.

The cavity 38 having a bottom is formed in a member of the piston rod 21 in the shock absorber 1 having a constitution described above. The cavity 38 is formed on the axial center 3 of the piston rod 21 and preferably has a circular or substantially circular cross-section. A bottom on a side of one end of the cavity 38 is positioned at the base end 22 of the piston rod 21, and the other end of the cavity 38 is the opening 39 opened from an end surface of the extended end of the piston rod 21 to the external force.

An internal thread 40 is formed on an inner circumference of the opening 39. The opening 39 can be opened and closed by a lid 41 preferably in a shape of a bolt screwed into internal thread 40. In addition, a seal 42 is interposed between the end surface of the extended end of the piston rod 21 and the lid 41.

The flowable matter 44 is filling and sealed in the cavity 38. When the lid 41 is twisted and turned to open the opening 39, the flowable matter 44 can be removed or filled in relation to the cavity 38 via the opening 39. In addition, an elastic body 45 made of rubber preferably is removably fitted in the opening 39. The elastic body 45 is compressed elastically by screwing the lid 41. In addition, the flowable matter 44 enclosed in the cavity 38 is pressurized by the elastic body 45.

A substance having a rheological characteristic is preferably used as the flowable matter 44. Rheology is “the study of the deformation and flow of a material.” Familiar liquids such as water and alcohol are subsequently understood as Newtonian fluids having a characteristic in which shear rate and shear stress are proportional to each other. On the other hand, the rheological characteristic refers to a characteristic of non-Newtonian fluid, in which no simple proportional relationship is seen between shear rate and shear stress in a flow of matter having flowability in a broad sense including fine particles (including grains) and the like of inorganic matters such as a plastic solid matter and sand.

More particularly, major substances that can constitute the flowable matter 44 having the rheological characteristic are as follows.

The major substances include granular fluid classified on the basis of a non-linear relationship between shear rate and shear stress (sand and the like), dilatant fluid (a mixture of starch as a high viscosity material and water, a mixture of sand and water in an appropriate combination, and the like), pseudo-plastic fluid (suspension or emulsion such as a solution or a melt of a high molecular material, starch paste, and cellulose ester and the like), and Bingham fluid (clay slurry, asphalt, paint, grease, and the like).

In addition, the major substances also include thixotropy fluid and rheopexy fluid (gypsum suspension and bentonite suspension, high-temperature bentonite grease of a non-soap type) having time hysteresis concerning the non-linear relationship between shear rate and shear stress, and visco-elastic fluid showing an elastic behavior in addition to a viscous behavior in relation to a shear strain (a concentrated solution and a melt of a polymer), and the like.

In a preferred embodiment of the present invention, sand as granular fluid preferably is used alone as the flowable matter 44.

When the vehicle is running, an impact force may be applied from an outside in the axial direction to the shock absorber 1, and therefore the shock absorber 1 may perform the expanding operation A in the direction of the bias of the suspension spring 34. In this case, the hydraulic fluid 14 in the first fluid chamber 19 starts to flow toward the second fluid chamber 20, passing through the expansion side fluid passage 27 in the expansion side damping force generation section 26. Accordingly, the expansion side damping valve 28 causes elastic deformation and opens the valve due to fluid pressure of the hydraulic fluid 14 in the first fluid chamber 19, which is larger than the elastic bias of the expansion side damping valve 28. As a result, the hydraulic fluid 14 flows in the expansion side fluid passage 27 that is slightly opened. Consequently, damping force is generated, and the impact force is damped.

On the other hand, the shock absorber 1 may perform the compressing operation B in resistance to the bias of the suspension spring 34 by the impact force. In this case, the hydraulic fluid 14 in the second fluid chamber 20 starts to flow toward the first fluid chamber 19, passing through the compression side fluid passage 31 in the compression side damping force generation section 30. Accordingly, the compression side damping valve 32 causes elastic deformation and opens the valve due to fluid pressure of the hydraulic fluid 14 in the second fluid chamber 20, which is larger than the elastic bias of the compression side damping valve 32. As a result, the hydraulic fluid 14 flows in the compression side fluid passage 31 that is slightly opened. Consequently, a damping force is generated, and the impact force is damped.

After this, the shock absorber 1 performs the expanding operation A and the compressing operation B repeatedly. As a result, the impact force is damped. As the shock absorber 1 performs the expanding operation A and the compressing operation B, the piston rod 21 moves in to or out of the fluid chamber 15. On this occasion, since the volume of the hydraulic fluid 14 of an incompressible type in the fluid chamber 15 is constant, the free piston 13 slides in the axial direction as much as the volume of the piston rod 21 moving into or out of the fluid chamber 15 as described above. As a result, gas in the gas chamber 16 is expanded and compressed. Consequently, the piston rod 21 can move into or out of the fluid chamber 15.

In addition, when an impact force is applied to the shock absorber 1, vibration of a high frequency and a micro-amplitude is generated in the axial direction of the shock absorber 1. This vibration is suppressed by the flowable matter 44. Specifically, “deformation resistance” (viscous resistance, frictional resistance, and the like) is generated in the flowable matter 44 by vibration generated in the shock absorber 1, and further “deformation resistance” (see the above) of the flowable matter 44 is also generated in relation to an inner wall surface of the cavity 38. Consequently, the vibration is suppressed by generation of the “deformation resistance” of the flowable matter 44. Moreover, the flowable matter 44 can efficiently suppress vibration in a wider frequency range in comparison with the dynamic damper according to the conventional art. Consequently, the vibration is suppressed more surely.

In other words, according to the shock absorber 1, an impact force applied to the shock absorber 1 is damped by the expansion side damping force generation section 26 and the compression side damping force generation section 30, and vibration of a high frequency in a wide range and a micro-amplitude generated in the shock absorber 1 by the impact force is more reliably and efficiently suppressed by the flowable matter 44. Therefore, the impact force is damped more effectively. As a result, ride comfort and quietness of the vehicle are improved.

Further, in general, the flowable matter 44 is not easily deteriorated over time in comparison with the elastic body made of rubber in the dynamic damper according to the conventional art. Consequently, a vibration suppression characteristic of the flowable matter 44 is prevented from being deteriorated at an early stage in the product life cycle. As a result, an improvement in the lifetime of the shock absorber 1 is achieved.

Moreover, the flowable matter 44 is sealed in the cavity 38 formed in the member of the piston rod 21. In other words, the flowable matter 44 is provided by utilizing an inside of the member of the piston rod 21. Therefore, the flowable matter 44 can be added without increasing the size of the shock absorber 1. As a result, excellent assembly and installation performance of the shock absorber 1 in relation to a vehicle or the like can be achieved by avoiding any increase in size of the shock absorber 1 despite the fact that the shock absorber 1 can effectively damp impact forces as described above.

In addition, as described above, the cavity 38 preferably is formed in the piston rod 21, and the opening 39 which makes it possible to remove or fill the flowable matter 44 to the cavity 38 is preferably formed at the extended end of the piston rod 21.

Consequently, it is possible to remove or fill the flowable matter 44 in relation to the cavity 38 from the opening 39 outside the cylinder tube 2. As a result, it is possible to change or adjust a type or an amount of the flowable matter 44 easily and conveniently without disassembling the shock absorber 1.

In addition, the opening 39 is formed at the extended end of the piston rod 21. Therefore, when a seal is applied in a case that the opening 39 is closed by the lid 41, it is not necessary to take the hydraulic fluid 14 into consideration. It is only necessary to consider a seal between a side of atmospheric air and a side in the cavity 38. Consequently, the shock absorber 1 can be easily formed. Further, because a leak does not occur respectively between the hydraulic fluid 14 and the flowable matter 44 in the cavity 38, reliability of the seal is enhanced.

Further in addition, as described above, the flowable matter 44 sealed in the cavity 38 preferably is pressurized.

Consequently, in particular, when the flowable matter 44 is a granular fluid, cohesion of each grain in the granular fluid is increased. Consequently, “deformation resistance” in the flowable matter 44 generated by the impact force is more frequently generated, and vibration generated in the shock absorber 1 by the impact force is suppressed more effectively.

Moreover, as described above, the flowable matter 44 preferably is a granular fluid, and more preferably is sand. Further, the granular fluid can be easily handled, for example, when filled in the cavity 38. In addition, a desired characteristic can be obtained relatively easily. Consequently, as the flowable matter 44 is the granular fluid, the shock absorber 1 can be easily formed.

As described above, sand as the granular fluid preferably is used alone as the flowable matter 44. However, another constitution is possible as described below.

The flowable matter 44 may also include at least one of a first granular fluid having a first absolute specific gravity and a liquid having a second absolute specific gravity, and a second granular fluid having a third absolute specific gravity larger than the first absolute specific gravity and the second absolute specific gravity.

In this constitution, when the flowable matter 44 vibrates with the shock absorber 1 due to the impact force, the “deformation resistance” in the flowable matter 44 is further more frequently generated because of differences in inertial forces caused by differences in the absolute specific gravities between the substances. As a result, vibration generated in the shock absorber 1 by the impact force is suppressed even more effectively.

Furthermore, the flowable matter 44 can include a granular fluid, and the granular fluid can be made of mixed grains having different grain diameters.

In this constitution, a grain having a small grain diameter enters a space produced between grains having a large grain diameter. Therefore, a contact area between these grains and a contact area between an inner surface of the cavity 38 and the flowable matter 44 become larger. Consequently, the “deformation resistance” in the flowable matter 44 generated by the impact force is even more frequently generated, and vibration generated in the shock absorber 1 by the impact force is suppressed even more effectively.

Moreover, when the flowable matter 44 vibrates with the shock absorber 1 due to the impact force, the “deformation resistance” in the flowable matter 44 is even more frequently generated because of differences in inertial forces caused by difference between the grain diameters of the grains. As a result, vibration generated in the shock absorber 1 by the impact force is suppressed even more effectively.

Further, the flowable matter 44 may include a granular fluid, and surface treatment may be performed in order to adjust a coefficient of friction of a surface of each grain constituting the granular fluid.

In this case, the surface treatment is preferably performed to cause the surface of the grain to be rough in a grinding process by shot peening. In addition, the surface of the grain is coated with a resin material or an inorganic material. For instance, a surface of sand as a core is coated with a ceramics layer by vapor deposition and sputtering.

In this constitution, a coefficient of friction of each grain in the granular fluid is set to a desired value. Accordingly, an amount of the “deformation resistance” in the flowable matter 44 generated by the impact force can be made to be appropriate. In addition, if rigidity of a surface of each grain is enhanced by the surface treatment, deterioration over time of the flowable matter 44 can be prevented, and improvement of a lifetime is achieved.

Moreover, adsorptive power may be generated respectively between components of the flowable matter 44, or adsorptive power may be generated respectively between the flowable matter 44 and an inner surface of the cavities 38 and 69.

In this case, specifically, the tube main body 4 and of the cylinder tube 2 and the piston rod 21 is preferably made of steel as a ferromagnetic material or other suitable material. On the other hand, the flowable matter 44 preferably is magnetized ferrite powder or other suitable material.

In this constitution, because adsorptive power is generated respectively between components of the flowable matter 44 and between the flowable matter 44 and an inner surface of the cavity 38, each friction force is increased. Consequently, an amount of “deformation resistance” in the flowable matter 44 generated by the impact force can be made to be larger.

In addition, when the shock absorber 1 is vibrated, a state of each adsorption due to the adsorptive power and a state of separation in which the state of the adsorption is released by the vibration are repeated. Accordingly, abrupt internal agitation is generated in the flowable matter 44. Consequently, the “deformation resistance” in the flowable matter 44 is further more frequently generated. As a result, vibration generated in the shock absorber 1 by the impact force is suppressed even more effectively.

The description above is based on the example shown in FIG. 1. However, the shock absorber 1 can be applied to an industrial machine and the like. Further, the expansion side damping force generation section 26 and the compression side damping force generation section 30 may be provided outside the cylinder tube 2 or may be formed in a material of the cylinder tube 2 (inside the material by increasing wall thickness). Still further, the elastic body 45 may not be provided, and the flowable matter 44 may be pressurized after the opening 39 is closed by the lid 41.

In addition, a rheological flow characteristic can be effectively utilized in order to generate damping force having a characteristic not obtained solely by adjusting viscosity of Newtonian fluid depending on non-linearity of viscosity, time irreversibility, and the like.

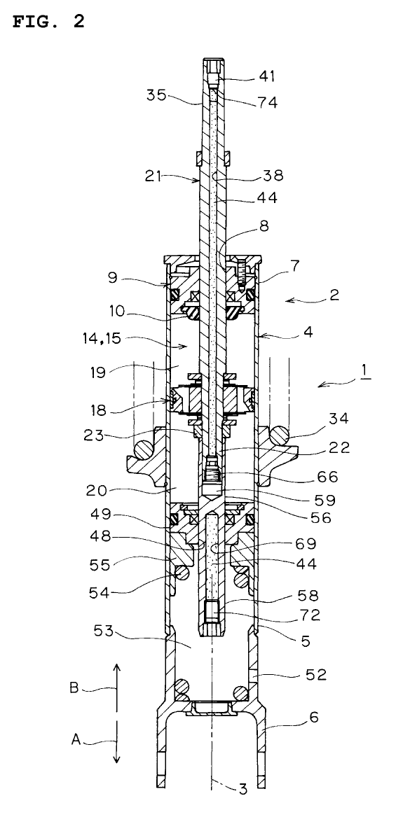

FIGS. 2 to 6 show additional preferred embodiments of the present invention. These additional preferred embodiments have many features and characteristics in common with the preferred embodiment described above. Therefore, common reference numerals will be included in FIGS. 2-6, the descriptions of common elements will not be repeated, and different points will be mainly described. In addition, the various elements, features and characteristics described with to the various additional preferred embodiments may be variously combined with that of other preferred embodiments of the present invention.

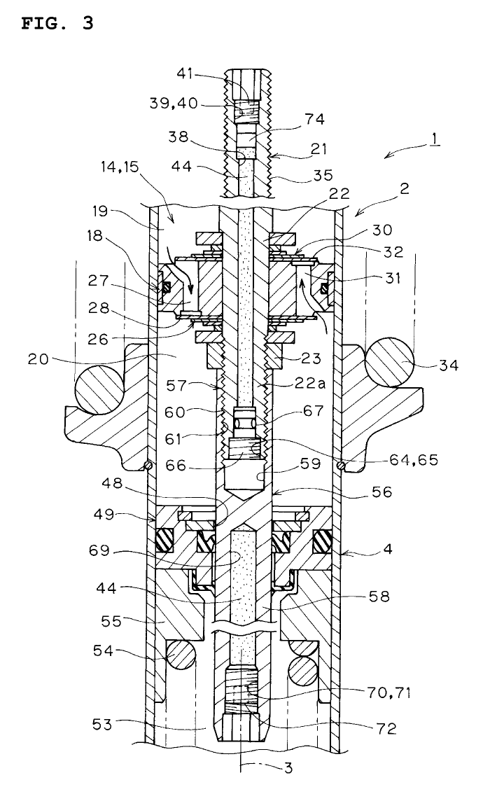

A second preferred embodiment of the present invention will be described hereinafter with reference to FIGS. 2 and 3.

In FIGS. 2 and 3, the shock absorber 1 in the second preferred embodiment preferably is of a so-called through rod (double rod) type. Areas under fluid pressure of the hydraulic fluid 14 on surfaces in the axial direction of the piston 18 in the shock absorber 1 preferably have generally the same dimensions.

Specifically, a movable rod guide 49 through which a through hole 48 is formed on the axial center 3 is provided in place of the free piston 13 of the first preferred embodiment. The movable rod guide 49 is fitted in the tube main body 4 of the cylinder tube 2 slidably in the axial direction. Further, a housing chamber 53 passing through a connection hole 52 formed in the head cover 6 and connected to the atmosphere is formed in place of the gas chamber 16 of the first preferred embodiment. The housing chamber 53 is formed with one end 5 of the tube main body 4 and the head cover 6. A spring 54 elastically pushing the movable rod guide 49 toward a side of the fluid chamber 15 is housed in the housing chamber 53. A prescribed amount of pressure is constantly applied to the hydraulic fluid 14 in the fluid chamber 15 by a bias of the spring 54.

A slider 55 in a shape of a cylinder in which a through hole is formed on the axial center 3 is interposed between the movable rod guide 49 and the spring 54. The slider 55 is fitted slidably in the axial direction without any rattle in the tube main body 4. One end surface (an upper end surface) in the axial direction of the slider 55 is preferably arranged perpendicular or substantially perpendicular to the axial center 3 and is in contact with one end surface (a lower end surface) in the axial direction of the movable rod guide 49.

One end surface (an upper end surface) in the axial direction of the spring 54 pressed on an other end surface (a lower end surface) of the slider 55 in a free state of the spring 54 may be somewhat inclined in relation to a perpendicular surface concerning the axial center. Even so, it is prevented that the slider 55 starts to incline in relation to the axial center 3 under the influence of the bias of the spring 54. Consequently, it is also prevented that the movable rod guide 49 in contact with the one end surface of the slider 55 starts to incline in relation to the axial center 3 under the influence of the bias of the spring 54. As a result, a smooth sliding of the movable rod guide 49 to the tube main body 4 is secured.

The other piston rod 56 positioned on the axial center 3, extending from the piston 18, passing through the through hole 48, and reaching the housing chamber 53 is provided. The piston rod 56 is provided with the base end 22 of the piston rod 21 fixed on the piston 18 and a rod main body 58 fixed on a projected end 22a of the base end 22 projecting from the piston 18 to the second fluid chamber 20 by a fastener 57. In other words, the base end 22 is shared by the piston rods 21 and 56. Diameters of the piston rods 21 and 56 preferably are generally the same.

As described above, the piston rods 21 and 56 preferably having generally the same diameter are extended from each surface in the axial direction of the piston 18. Accordingly, as described above, the areas under fluid pressure on the surfaces in the axial direction of the piston 18 preferably have generally the same dimensions. As a result, the piston 18 is prevented from receiving pressurizing reaction force from the spring 54.

A fitting hole 59 having a bottom is formed at a base end of the rod main body 58 on the axial center 3. The fastener 57 is provided with an external thread 60 formed on an outer circumference of the projected end 22a of the base end 22 and an internal thread 61 formed on an inner circumference of the fitting hole 59. The fitting hole 59 of the rod main body 58 is fitted with the projected end 22a of the base end 22, and the external thread 60 and the internal thread 61 are screwed. Consequently, a bottom section in the fitting hole 59 is a space enclosed by the projected end 22a of the base end 22.

The cavity 38 passes through the projected end 22a of the base end 22, further passes through another opening 64 formed in the projected end 22a, and is opened to a bottom in the fitting hole 59. An internal thread 65 is formed on an inner circumference of the other opening 64. The other opening 64 can be opened and closed by a lid 66 in a shape of a bolt screwed with the internal thread 65. In addition, a seal 67 is interposed between the inner circumference of the opening 64 and the lid 66.

Another cavity 69 having a bottom is formed in a member of the rod main body 58 in the other piston rod 56. The other cavity 69 is formed on the axial center 3 of the piston rod 56. The other cavity 69 preferably has a circular or substantially circular cross-section, and its diameter is larger than that of the cavity 38. In addition, an opening 70 which opens the other cavity 69 to the housing chamber 53 is formed at an extended end of the other piston rod 56.

An internal thread 71 is formed on an inner circumference of the opening 70. The opening 70 can be opened and closed by a lid 72 in a shape of a bolt screwed with the internal thread 71. In addition, a seal (not shown) is provided between the inner circumference of the opening 70 and the lid 72. Sand as a granular fluid belonging to the flowable matter 44 is filled and sealed in the cavity 69.

When the shock absorber 1 is in a static state, the flowable matter 44 is not completely filled in the cavity 38 of the piston rod 21 so as to maintain the space 74 at an upper end of the cavity 38. Even if the cavity 38 is fully filled with the flowable matter 44 at a time when the flowable matter 44 is injected, the cavity 38 may be incompletely filled with the flowable matter 44 as described above after a certain period of time elapses in a case that the flowable matter 44 is a granular fluid. Specifically, even if the flowable matter 44 is fully enclosed in the cavity 38, each grain of the granular fluid sinks as time passes because of its own weight. Accordingly, since the apparent specific gravity of the granular fluid is gradually increased, the space 74 may be generated at the upper end of the cavity 38.

In the constitution described above, when the flowable matter 44 vibrates with the shock absorber 1 due to the impact force, fluidization of the flowable matter 44 in the cavity 69 is accelerated by the space 74 provided as described above. As a result, the “deformation resistance” in the flowable matter 44 generated by the impact force is more frequently generated, and vibration generated in the shock absorber 1 by the impact force is suppressed more effectively.

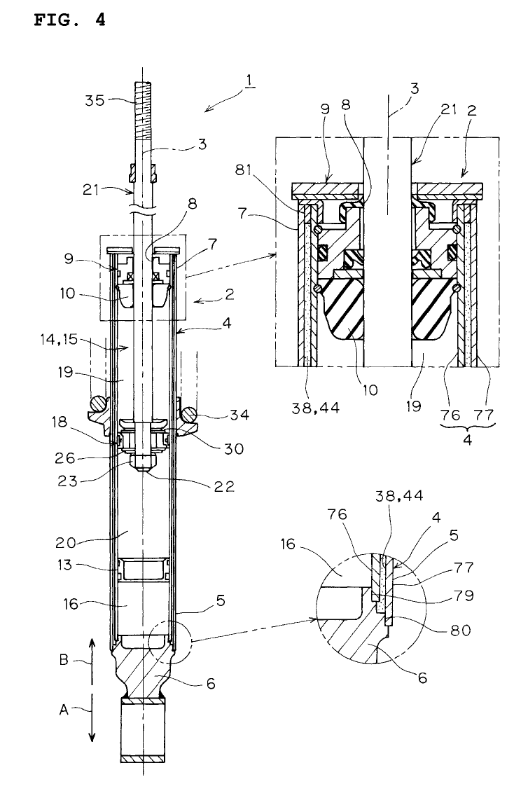

A third preferred embodiment of the present invention will be described hereinafter with reference to FIG. 4.

In FIG. 4, the tube main body 4 of the cylinder tube 2 preferably is constituted by a multiple-part tube including inner and outer tube main bodies 76 and 77. An outer circumference of the head cover 6 has a small diameter section 79 and a large diameter section 80, and the small and the large diameter sections 79 and 80 are shifted in position from each other. An end of the inner tube main body 76 is externally fitted and fixed with the small diameter section 79, and an end of the outer tube main body 77 is externally fitted with the large diameter section 80. On the other hand, a spacer 81 in a shape of a ring is interposed between the inner and the outer tube main bodies 76 and 77 at the other end 7 of the tube main body 4.

Further, the cavity 38 in a shape of a cylinder is formed between the inner and the outer tube main bodies 76 and 77, and the flowable matter 44 is sealed in the cavity 38. An effect by the cavity 38 and the flowable matter 44 is the same as that of the preceding preferred embodiment.

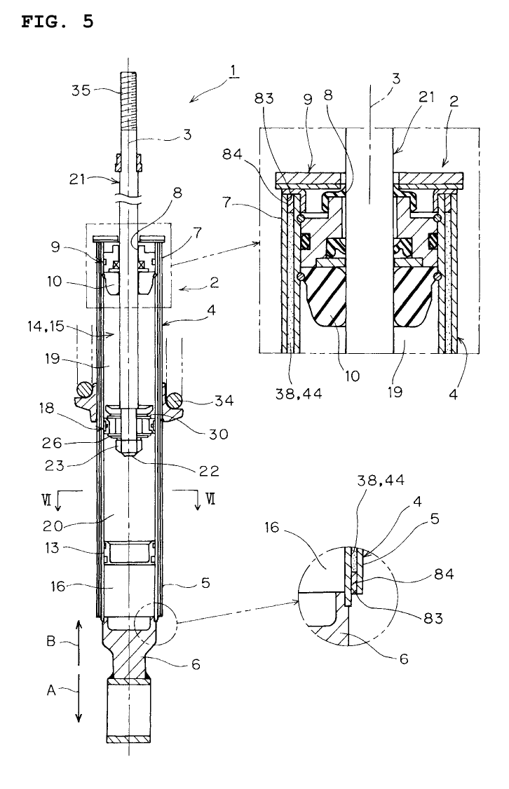

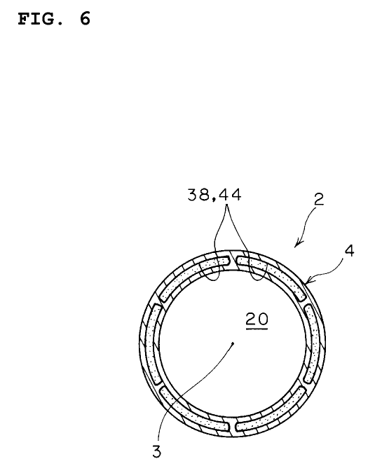

A fourth preferred embodiment of the present invention will be described hereinafter with reference to FIGS. 5 and 6.

In FIGS. 5 and 6, the tube main body 4 of the cylinder tube 2 is preferably formed by extrusion. A plurality of the cavities 38 (for example, six cavities) passing through a member of the tube main body 4 in the axial direction are formed. Cross-sections of the cavities 38 define a circular or substantially circular arc with the axial center 3 at the center, and each cross-section preferably is in the same shape and of the same size and disposed at a regular pitch in the direction of a circumference around the axial center 3. A stopper 84 closing an opening 83 of each end in the longitudinal direction of each cavity 38 is provided.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A hydraulic shock absorber, comprising:
a cylinder tube;
a piston fitted slidably in an axial direction in the cylinder tube so as to divide an inside of the cylinder tube into first and second fluid chambers;
a piston rod extending from the piston to an outside of the cylinder tube; and
a damping force generation section arranged to generate a damping force by making hydraulic fluid flow between the first and the second fluid chambers; wherein
at least one cavity is provided in at least one of the cylinder tube and the piston rod; and
flowable matter having a rheological characteristic is sealed in the at least one cavity.

2. The hydraulic shock absorber according to claim 1, wherein the at least one cavity is formed in a portion of the piston rod, and an opening which arranged to enable removal or filling of the flowable matter to the at least one cavity is located at an extended end of the piston rod.

3. The hydraulic shock absorber according to claim 1, wherein the flowable matter sealed in the at least one cavity is pressurized.

4. The hydraulic shock absorber according to claim 1, wherein the flowable matter is a granular fluid.

5. The hydraulic shock absorber according to claim 1, wherein the flowable matter includes:
(a) at least one of a first granular fluid having a first absolute specific gravity and a liquid having a second absolute specific gravity; and
(b) a second granular fluid having a third absolute specific gravity that is larger than the first absolute specific gravity and the second absolute specific gravity.

6. The hydraulic shock absorber according to claim 1, wherein the flowable matter includes a granular fluid made of mixed grains having different grain diameters.

7. The hydraulic shock absorber according to claim 1, wherein the flowable matter includes a granular fluid that has been surface treated to adjust a coefficient of friction of a surface of each grain constituting the granular fluid.

8. The hydraulic shock absorber according to claim 1, wherein adsorptive power is generated respectively between components of the flowable matter, or adsorptive power is generated respectively between the flowable matter and an inner surface of the cavity.

9. The hydraulic shock absorber according to claim 1, wherein the flowable matter is not completely filled in the cavity in order to maintain a space at an upper end of the cavity.
